(19) United States
(12) Patent Application Publication
(10) Pub. No.: US 2014/0136824 A1
(43) Pub. Date: May 15, 2014

(54) METHOD FOR PRODUCING MASTER DISK

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: Hai-Yun LONG, Shenzhen (CN); Gao-Feng JIA, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/965,159

(22) Filed: Aug. 12, 2013

(30) Foreign Application Priority Data
Nov. 15, 2012 (CN) 2012104600833

(51) Int. Cl. G06F 9/44

(52) U.S. Cl. CPC G06F 9/4401
USPC 713/1

(57) ABSTRACT

In a method for producing a master disk from which data is copied to electronic products before shipping, a user operating system is installed into a master disk, and the master disk is partitioned to include at least one OS partition for storing a user operating system. When there is a DATA partition for user data in the master disk, a test operating system is installed into the DATA partition, then booting is set to take place from the DATA partition. When there is no DATA partition, a sub-partition is separated from the OS partition, and a test operating system is installed into the sub-partition, and booting is set to take place from the sub-partition.

### BACKGROUND

1. Technical Field

Embodiments of the present disclosure relate to electronic product testing, and more specifically relates to a method for producing a master disk for testing electronic products.

2. Description of Related Art

For ensuring quality of electronic products, such as computers, smart phones, and so on, it is necessary to test hardware configurations and performances of the electronic products before the electronic products leave the factories. Thus, a test operating system is needed to be installed into the electronic products for testing in production lines. After testing, the test operating system is further needed to be deleted from the electronic products, and then a user operating system is installed into the electronic products for use by end users.

There are hundreds or even thousands of electronic products, thus the above operations are troublesome and time consuming.

### BRIEF DESCRIPTION OF THE DRAWINGS

FIG. 1 is a block diagram of one embodiment of a hardware environment of executing a method for producing master disks for testing electronic products.

FIG. 2 illustrates a flowchart of one embodiment of the method for producing master disk.

FIG. 3 and FIG. 4 illustrate partitions of a master disk.

FIG. 5 illustrates a flowchart of one embodiment of a method for testing electronic products using the master disk built according to the method of FIG. 2.

### DETAILED DESCRIPTION

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device.

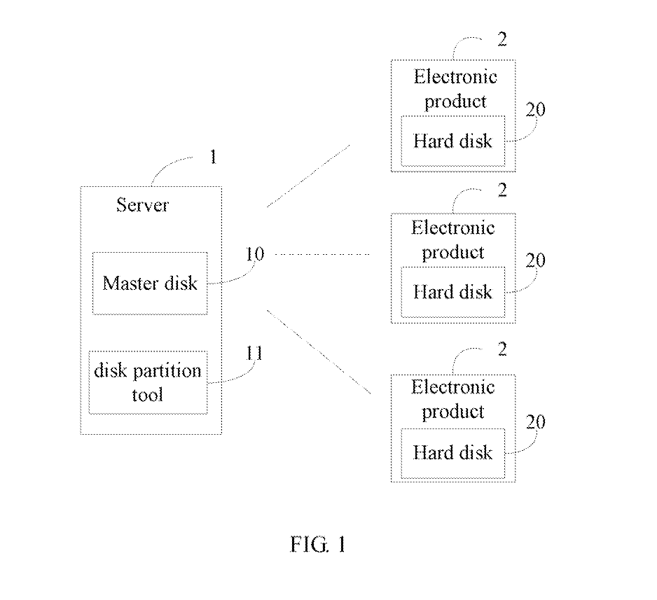

FIG. 1 is a block diagram of one embodiment of a hardware environment of executing a method for producing master disks for testing electronic products. The hardware environment is constituted by a server 1 and a plurality of electronic products 2. The server 1 includes a master disk 10 and a disk partition tool 11. Each of the electronic products 2 includes a hard disk 20. The master disk 10 is a hard disk that is supplied to a duplication or replication house for information to be copied on to blank hard disks, such as each hard disk 20, as many times as required. The disk partition tool 11 splits the master disk 10 into partitions, so that different types of data can be stored separately. In one embodiment, the master disk 10 may include only one partition, namely an OS partition which is used to store an operating system. In another embodiment, the master disk 10 may include at least two partitions split by the disk partition tool 11, including an OS partition and a DATA partition, where the DATA partition is used to store user data.

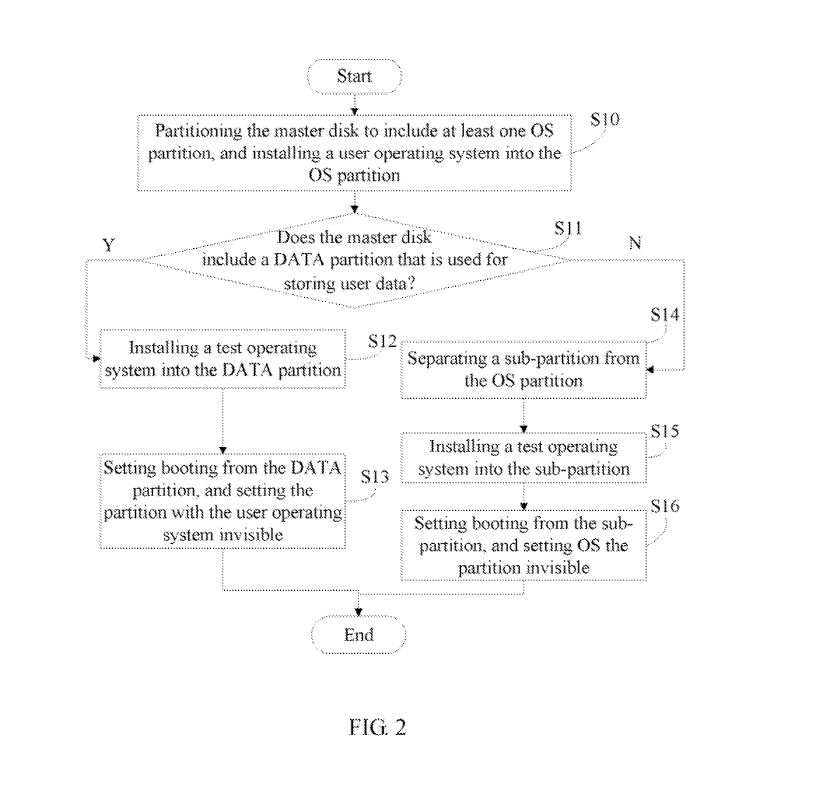

FIG. 2 illustrates a flowchart of one embodiment of the method for producing a master disk for testing electronic products. The method is executed by at least one processor of a computing device, such as the server 1 of FIG. 1. Depending on the embodiment, additional steps in FIG. 2 may be added, others removed, and the ordering of the steps may be changed.

In step S10, the disk partition tool 11 is used to partition the master disk 10 into one or more partitions including at least one OS partition, and installs a user operating system, such as ANDROID, IOS, WINDOWS, WINDOWS PHONE, and others, into OS partition of the master disk 10.

In step S11, the disk partition tool 11 determines if the master disk 10 includes a DATA partition which is used to store user data. Steps S12 and S13 are implemented when the master disk 10 includes the DATA partition. Otherwise, step S14-S16 are implemented when the master disk 10 does not include a DATA partition.

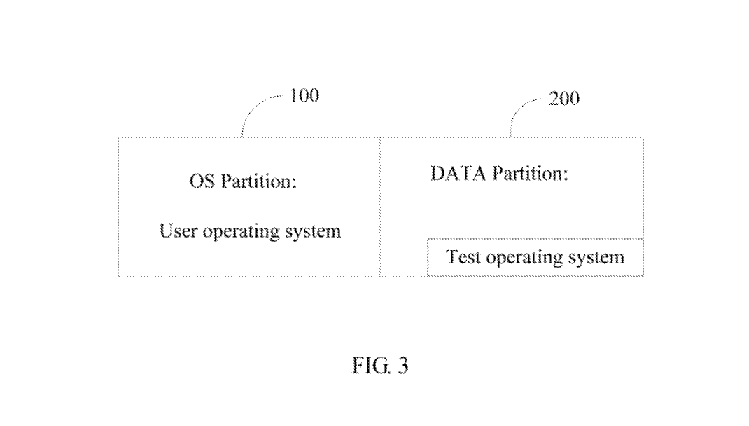

In step S12, the disk partition tool 11 installs a test operating system into the DATA partition. In step S13, the disk partition tool 11 sets booting from the DATA partition, enabling an electronic device which has a hard disk cloned by the master disk 10 to boot up from the DATA partition of the hard disk, and sets the OS partition as invisible, then, the procedure ends. Referring to FIG. 3, the master disk 10 of the embodiment includes at least the OS partition 100 and the DATA partition 200. The disk partition tool 11 installs the test operating system into the DATA partition 200.

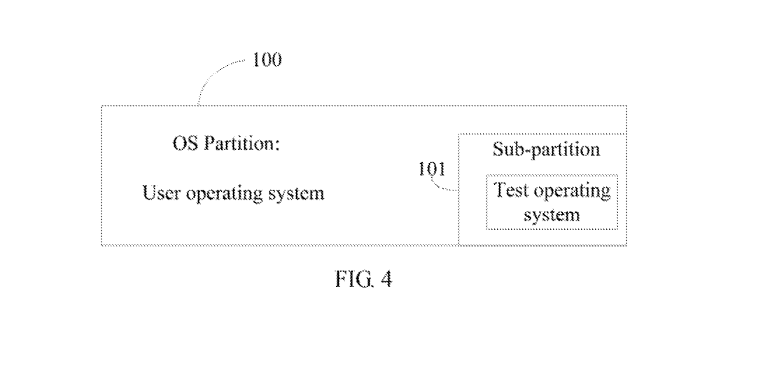

In step S14, the disk partition tool 11 separates a sub-partition from the OS partition which has the user operating system installed therein, and in step S15, the disk partition tool 11 installs the test operating system into the sub-partition. In step S16, the disk partition tool 11 sets booting from the sub-partition enabling an electronic device which has a hard disk cloned by the master disk 10 to boot up from the sub-partition of the hard disk ,and sets the OS partition as invisible, then, the procedure ends. Referring to FIG. 4, the master disk 10 of the embodiment includes the OS partition 100. The disk partition tool 11 separates a sub-partition 101 from the OS partition 100, and then installs the test operating system into the sub-partition 101.

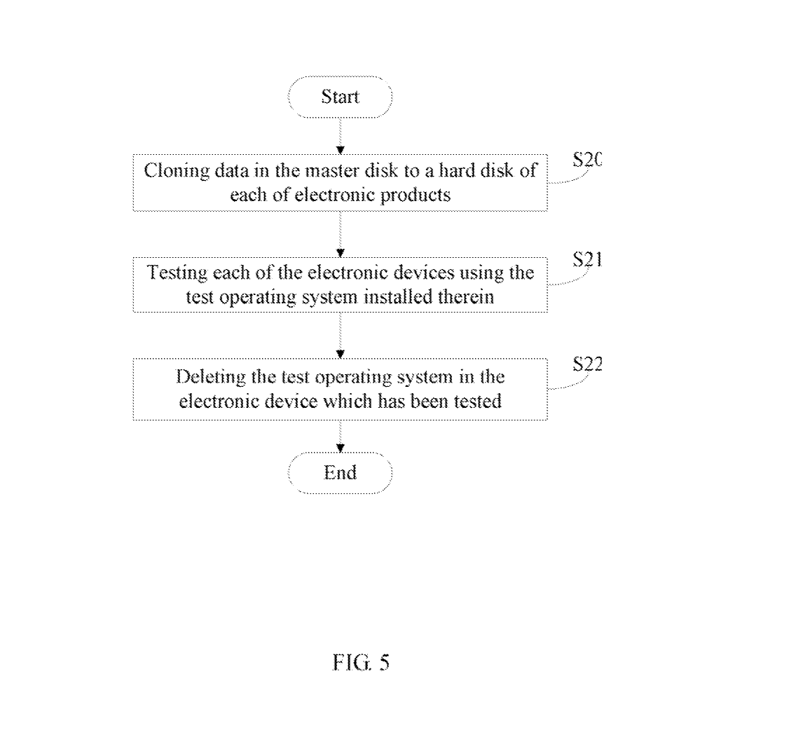

FIG. 5 illustrates a flowchart of one embodiment of a method for testing electronic products using the master disk of FIG. 1. Depending on the embodiment, additional steps in FIG. 5 may be added, others removed, and the ordering of the steps may be changed.

In step S20, the master disk 10 clones data from within itself to the hard disk 20 of each of the electronic products 2. The data includes, but is not limited to, the test operating system and the user operating system.

In step S21, a test of each of the electronic products 2 is performed using the test operating system installed therein.

In step S22, the test operating system is deleted from each of the electronic products 2 after the test has finished by formatting the DATA partition or the sub-partition in which the test operating system is installed.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A method for producing a master disk, the method comprising:
partitioning the master disk to comprise at least one operating system (OS) partition, and installing a user OS into the master disk, and;
when there is a DATA partition in the master disk, installing a test operating system into the DATA partition, and setting booting from the DATA partition, enabling an electronic device which has a hard disk cloned by the master disk to boot up from the DATA partition of the hard disk; and
when there is no DATA partition which is used to store user data in the master disk, separating a sub-partition from the OS partition, installing a test operating system into the sub-partition, and setting booting from the sub-partition enabling an electronic device which has a hard disk cloned by the master disk to boot up from the sub-partition of the hard disk.

2. The method according to claim 1, further comprising:
setting the OS partition as invisible.

3. The method according to claim 1, further comprising:
cloning data of the master disk to a hard disk of each of electronic products, wherein the data comprises the test operating system and the user operating system.
testing each of the electronic products using the test operating system; and
deleting the test operating system from the hard disk of each of the electronic product after the test is performed by formatting the DATA partition or the sub-partition in which the test operating system is installed.

4. A master disk, comprising:
an OS partition in which a user operating system is installed; and
a DATA partition in which a test operating system is installed.

5. A master disk, comprising:
an OS partition in which a user operating system is installed; and
a sub-partition which is separated from the OS partition, and in which a test operating system is installed.
